(19) United States
(12) Patent Application Publication
(10) Pub. No.: US 2003/0194995 A1
(43) Pub. Date: Oct. 16, 2003

(54) Telecommunications system with geographically discriminate broadcasting

(75) Inventors: Kevin Burke Handerson, Boonton, NJ (US); Paul C. Ross, Morris Plains, NJ (US); Richard Herbert Rudman, Morristown, NJ (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ

(21) Appl. No.: 10/421,514

(22) Filed: Apr. 23, 2003

Related U.S. Application Data
(63) Continuation of application No. 09/312,580, filed on May 15, 1999.

(51) Int. Cl. H04Q 7/20

(52) U.S. Cl. 455/422.1; 455/414.2

(57) ABSTRACT

A method and system that broadcasts different messages into different geographic areas based on the appropriateness, desirability or necessity of broadcasting each messages to each area is disclosed. In particular, the illustrative embodiment of the present invention is a wireless telecommunications system that uses a portion of its spare bandwidth to broadcast messages to the receivers within its domain. The content of the messages can represent advertising, public service announcements, weather and stock reports, etc. One aspect of the illustrative embodiment is that the domain serviced by it is partitioned into a plurality of tessellated areas called “geographic regions.” From a single broadcast server, the various messages to be broadcast are broadcast not to the entire domain of the system, but to only those geographic regions within the domain where the content of those messages is appropriate, necessary or desirable.

### RELATED CASES

This application is a continuation of U.S. application Ser. No. 09/312,580 filed May 15, 1999, which is incorporated by reference herein in its entirety.

### FIELD OF THE INVENTION

The present invention relates to telecommunications in general, and, more particularly, to a telecommunications system that broadcasts different messages into different geographic areas based on the appropriateness, desirability or necessity of broadcasting each message to each area.

### BACKGROUND OF THE INVENTION

FIG. 1 depicts a schematic diagram of a portion of a typical wireless telecommunications system in the prior art, which system provides wireless telecommunications service to a number of wireless terminals (e.g., wireless terminals 101-1 through 101-3) that are situated within a geographic region. Each wireless terminal can be either stationary, as in a wireless local loop system, or mobile, as in a traditional cellular system.

The heart of a typical wireless telecommunications system is wireless switching center (“WSC”) 120, which might also be known as a mobile switching center (“MSC”) or a mobile telephone switching office (“MTSO”). Typically, wireless switching center 120 is connected to a plurality of base stations (e.g., base stations 103-1 through 103-5) that are dispersed throughout the geographic area serviced by the system and to the local and long-distance telephone and data networks (e.g., local-office 130, local-office 139 and toll-office 140). Wireless switching center 120 is responsible for, among other things, establishing and maintaining calls between wireless terminals and between a wireless terminal and a wireline terminal (e.g., wireline terminal 150), which is connected to the system via the local and/or long-distance networks.

The geographic region serviced by a wireless telecommunications system is partitioned into a number of spatially distinct areas called “cells.” As depicted in FIG. 1, each cell is schematically represented by a hexagon; in practice, however, each cell usually has an irregular shape that depends on the topography of the terrain serviced by the system. Typically, each cell contains a base station, which comprises the radios and antennas that the base station uses to communicate with the wireless terminals in that cell and also comprises the transmission equipment that the base station uses to communicate with wireless switching center 120.

For example, when wireless terminal 101-1 desires to communicate with wireless terminal 101-2, wireless terminal 101-1 transmits the desired information to base station 103-1, which relays the information to wireless switching center 120 over wireline 102-1. Upon receipt of the information, and with the knowledge that it is intended for wireless terminal 101-2, wireless switching center 120 then returns the information back to base station 103-1 over wireline 102-1, which relays the information, via radio, to wireless terminal 101-2.

Recently, a trend has developed in which the wireless telecommunications systems from different manufactures have become increasingly alike. From an economic perspective, the principal result of this lack of product differentiation is that it pushes the market for such systems towards a commodity market. When the market for any good or service approaches a commodity market, competition between different suppliers becomes less focused on product quality or features and more focused on price. Although wireless service providers (e.g., AT&T, Bell Atlantic, Sprint, etc.) welcome the emergence of a commodity market, wireless system manufacturers (e.g., Lucent Technologies, Ericsson, Motorola, Nokia, etc.) fear such a commodity market because it favors only the lowest cost supplier and narrows the operating margins of every supplier, even the lowest cost supplier.

The best way that a manufacturer can avoid the emergence of a commodity market is through product differentiation, whereby a manufacturer incorporates capabilities, features, and advantages into its product which its competition does not have. This enables the manufacturer to differentiate its products from those of its competitors and might enable the manufacturer to convince a buyer to pay a premium price for its products. This gives the manufacturer both a larger market share and relief in its operating margins.

Therefore, the need exists for a useful capability, feature or advantage that a wireless system manufacturer can incorporate into a wireless telecommunications system that will differentiate its equipment from its competitors and will encourage buyers to buy its system instead of those of its competitors.

### SUMMARY OF THE INVENTION

The present invention is a method and system that broadcasts different messages into different geographic areas based on the appropriateness, desirability or necessity of broadcasting each message to each area. In particular, the illustrative embodiment of the present invention is a wireless telecommunications system that uses a portion of its bandwidth to broadcast messages to receivers within its domain. The messages can, for example, contain advertising, public service announcements, weather and stock reports, etc.

Because the system is capable of providing broadcast service, as well as traditional telecommunications service, the system provides its owner/operator with two sources of revenue: (I) receipts from selling telecommunications service, and (2) receipts from selling broadcast service (e.g., advertising, etc.). The fact that this system provides a better opportunity for generating revenue than systems from other manufacturers encourages service providers to buy it, rather than systems from other manufacturers. Furthermore, because this additional feature enables service providers to earn substantially more than the feature costs, it encourages service providers to pay a premium for it. Therefore, the illustrative embodiment enables a telecommunications system manufacturer to differentiate its products from those of its competitors, increase its market share and increase its operating margins.

One aspect of the illustrative embodiment is that the domain serviced by it is partitioned into a plurality of tessellated areas called “geographic regions.” From a single broadcast server, the various messages to be broadcast are broadcast not to the entire domain of the system, but to only those geographic regions within the domain where the content of those messages is appropriate, necessary or desirable. This is advantageous because it uses the bandwidth capability of the illustrative embodiment efficiently. In contrast, if the broadcast messages were broadcast throughout the domain of the system, precious bandwidth would be wasted transmitting the messages to areas where their content is inappropriate, unnecessary or undesirable.

At the receiver, the broadcast messages are advantageously received and stored for later examination by the user of the receiver. This is advantageous because it enables the user to review all of the messages received over hours or days in a short period.

An illustrative embodiment of the present invention comprises: a first transmitter for broadcasting into a first geographic region; a second transmitter for broadcasting into a second geographic region; and a broadcast server for providing a first message to the first transmitter for broadcasting into the first geographic region, a second message to the second transmitter for broadcasting into the second geographic region, and a third message to the first transmitter for broadcasting into the first geographic region and to the second transmitter for broadcasting into the second geographic region.

### BRIEF DESCRIPTION OF THE DRAWINGS

FIG. 1 depicts a schematic diagram of a portion of a typical wireless telecommunications system in the prior art

FIG. 2 depicts a map of an illustrative domain, Blackacre.

FIG. 2a depicts a map of the domain, Blackacre, as it is partitioned into geographic regions.

FIG. 3 depicts a map of the domain, Blackacre, depicting the position of the wireless switching center, receiver and 23 geographically dispersed base stations.

FIG. 4 depicts a functional block diagram of the wireless switching center shown in FIG. 3.

FIG. 5 depicts a map of the domain, Blackacre, in which the geographic regions that receive Message #1 are shown hatched.

FIG. 6 depicts a map of the domain, Blackacre, in which the geographic regions that receive Message #2 are shown hatched.

FIG. 7 depicts a map of the domain, Blackacre, in which the geographic regions that receive Message #3 are shown hatched.

FIG. 8 depicts a map of the domain, Blackacre, in which the geographic regions that receive Message #4 are shown hatched.

FIG. 9 depicts a map of the domain, Blackacre, in which the geographic regions that receive Message #5 are shown hatched.

FIG. 10 depicts a map of the domain, Blackacre, in which the geographic regions that receive Message #6 are shown hatched.

FIG. 11 depicts a functional block diagram of the receiver shown in FIG. 3.

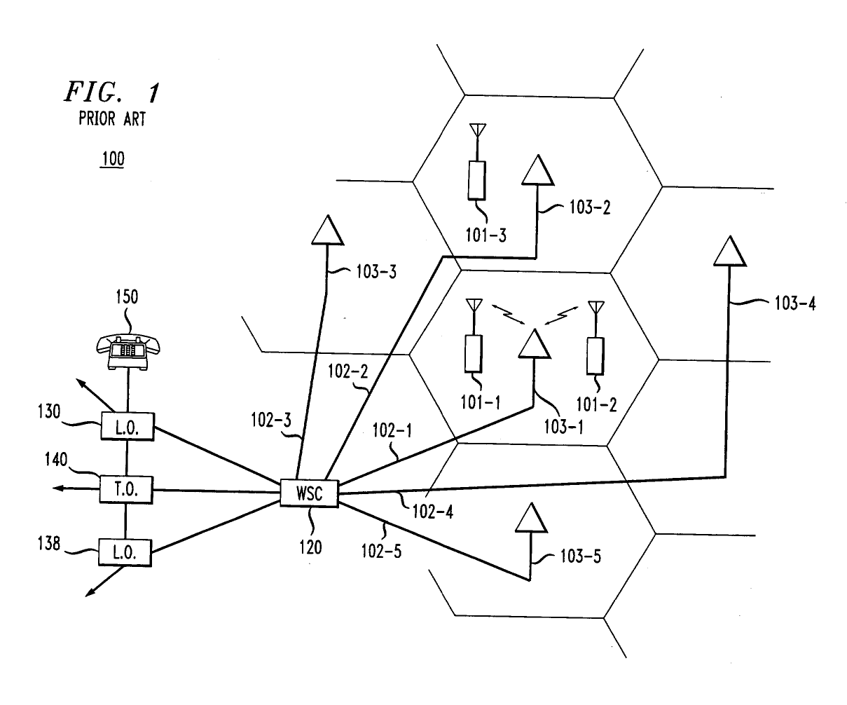

### DETAILED DESCRIPTION

The illustrative embodiment of the present invention provides both:

i. telecommunications service, and

ii. broadcast service to those receivers situated within a “domain.” For the purposes of this specification, a “domain” is defined as a geographic area of any size and shape, and can comprise any geographic and geologic features (e.g., political boundaries, man-made structures, rivers, mountains, etc.). For example, one domain might be defined to include New York, Vermont, Massachusetts west of the Connecticut River, Quebec, Ontario and Lake Erie. Another domain might be defined to include the Borough of Manhattan.

For the purposes of this specification, the phrase “telecommunications service” and its inflected forms are defined as a service for providing bi-directional communication at a distance by the transmission of electromagnetic signals. Examples of telecommunications service include: plain old telephone service (better known as “POTS”), Internet access, wireless and cellular telephone service, and two-way pager service, etc. Typical telecommunications service providers include the wireline and wireless telephone companies (e.g., AT&T, Bell Atlantic, Bell South, Sprint, etc.), the cable television companies (e.g., Media One, Cablevision, etc.), and the Internet service providers (e.g., America Online, Erols, etc.).

For the purposes of this specification, the phrase “broadcast service” and its inflected forms are defined as a service for providing uni-directional communication at a distance by the transmission of electromagnetic signals. Typically, broadcast service is implemented as a stream of independent messages, which can comprise voice, video, data, or any combination of these.

It will be understood to those skilled in the art that whereas telecommunications service is bi-directional and typically point-to-point, broadcast service is, in contrast, uni-directional and point-to-multipoint. Furthermore, a broadcaster is typically unaware of the number, identity or position of the receivers receiving its messages, but is aware of the geographic area into which its signal is transmitted and is receivable. Typical broadcasters include the radio and television stations, both wireless and wireline (e.g., WNBC, WABC, WCBS, CNN Headlines News, etc.).

Advantageously, the same telecommunications service is provided by the illustrative embodiment throughout the domain. This does not mean that telecommunications service subscribers cannot elect different calling features and options, however, but only that:

i. a call to anywhere in the geographic region can be placed from anywhere in the geographic region, and

ii. a call from anywhere in the geographic region can be received anywhere in the geographic region.

In contrast, the illustrative embodiment of the present invention endeavors to provide different broadcast service to disparate areas within the domain. In other words, the illustrative embodiment does not broadcast the same messages throughout the entire domain, but broadcasts different messages to different areas based on:

i. the relevance of the message to the particular area, or

ii. the desire or willingness of the publisher of the message to broadcast the message into different areas, or

iii. both i and ii.

As an example of the first case, a message pertaining to the flooding of a river might be broadcast to areas along the river and not to distant areas that could not be affected by the flooding. As an example of the second case, a message that is an advertisement for chewing gum might be equally relevant throughout the domain, but the advertiser might be unwilling to pay to have the message broadcast throughout the entire domain (e.g., because the advertising fees for such a wide distribution are prohibitive, etc.).

Therefore, to distinguish one area into which one set of messages is broadcast from another area into which another, possibly different, set of messages is broadcast, the domain is partitioned into a plurality of tessellated (i.e., contiguous) “geographic regions.” When a wireless telecommunications technology is used to provide the telecommunications and broadcast service, each geographic region is advantageously a “cell,” as term is understood to those skilled in the art.

Although the set of messages broadcast into one geographic region might be different than the set of messages broadcast into another, the set of messages broadcast into one geographic region is the same throughout the geographic region. For the purposes of this specification, a “geographic region” is defined as a portion of a domain of any size and shape, and that can comprise any geographic and geologic features. For example, if South Dakota (with 210,000 square kilometers) were defined as a domain, it might be partitioned into approximately 3000 tessellated geographic regions that are, on average, about 70 square kilometers in size. As another example, if the boroughs of Manhattan and the Bronx, and the Harlem River are defined as a domain, it might be partitioned into approximately 6000 tessellated geographic regions, each of which roughly corresponds to a square city block. It will be clear to those skilled in the art how to partition a domain into geographic regions depending on, among other things, the technology employed, the density of telecommunications service subscribers, the topography of the domain, the available bandwidth, etc.

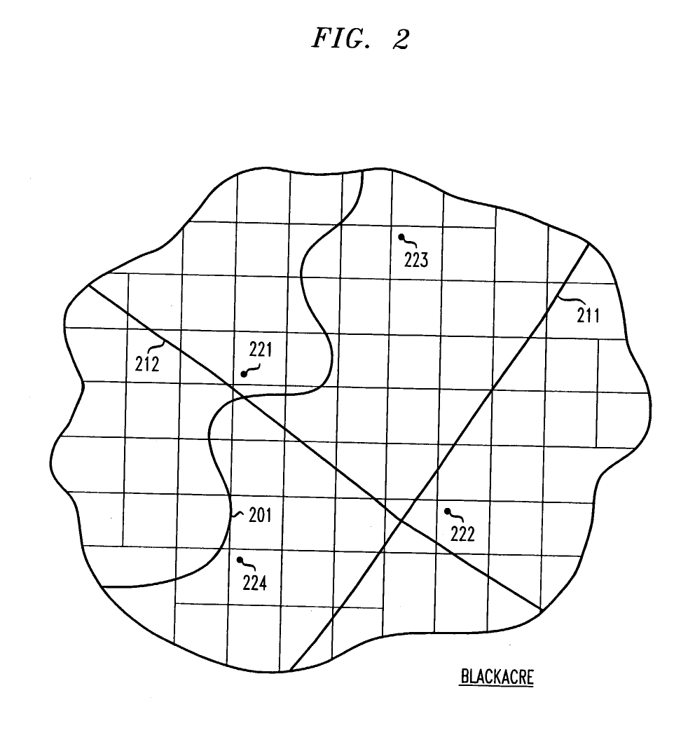

FIG. 2 depicts a map of an illustrative domain, Blackacre, that is useful in describing and understanding the illustrative embodiment of the present invention. Blackacre is an island of approximately 77 square kilometers, of irregular shape, that comprises: river 201, highways 211 and 212, business districts 221 and 222, and schools 223 and 224. Also contained within Blackacre, but not depicted, are residential and commercial buildings, streets, and other typical man-made structures. As shown in FIGS. 2 and 2a, Blackacre has been partitioned into 80 geographic regions, which have been arbitrarily designated as # 1 through #80. From FIGS. 2 and 2a, it can be observed that some of the 80 geographic regions are 1 kilometer by 1 kilometer squares and others are irregular in shape and of approximately 1 square kilometer in area.

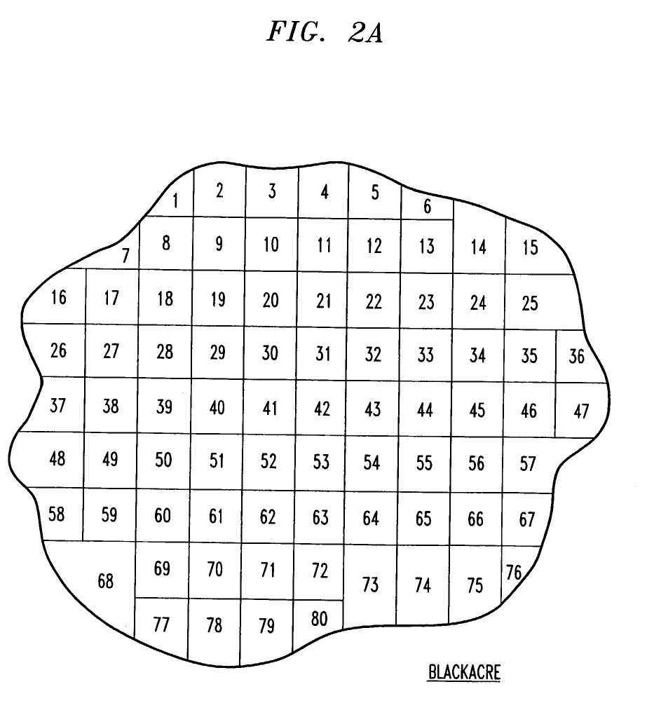

Although telecommunications and broadcast service can be provided to Blackacre by any of many well-known technologies (e.g., satellite, cable television, wireline telephone and digital subscriber loop, etc.), the illustrative embodiment of the present invention uses terrestrial wireless, in general, and wireless local loop, in particular. Therefore, as shown in FIG. 3, Blackacre comprises: wireless switching center 300, twenty-three geographically distributed wireless transmitters (e.g., base stations 301 to 323), and one or more receivers (e.g., wireless terminal 350). Wireless switching center 300 is connected to each of base stations 301 to 323 by wirelines (not shown), in well-known fashion, and wireless terminal 350 via base station 315 by a wireless channel. It will be clear to those skilled in the art how to make and use alternative embodiments of the present invention that use satellite, cable and wireline technologies.

It can be observed from FIG. 3 that each of the twenty-three base stations is responsible for providing telecommunications service and broadcast service to one or more geographic regions. For example, base stations 301 to 303, 310, 312 to 316, and 318 to 321 are each adjacent to four geographic regions, and, therefore, are responsible for providing telecommunications service and broadcast service to four geographic regions. Base station 317 is adjacent to three geographic regions, base stations 305, 311, 322 and 323 are adjacent to two geographic regions and base station 304 is within one geographic region. It will be clear to those skilled in the art how to make and use base stations 301 to 321.

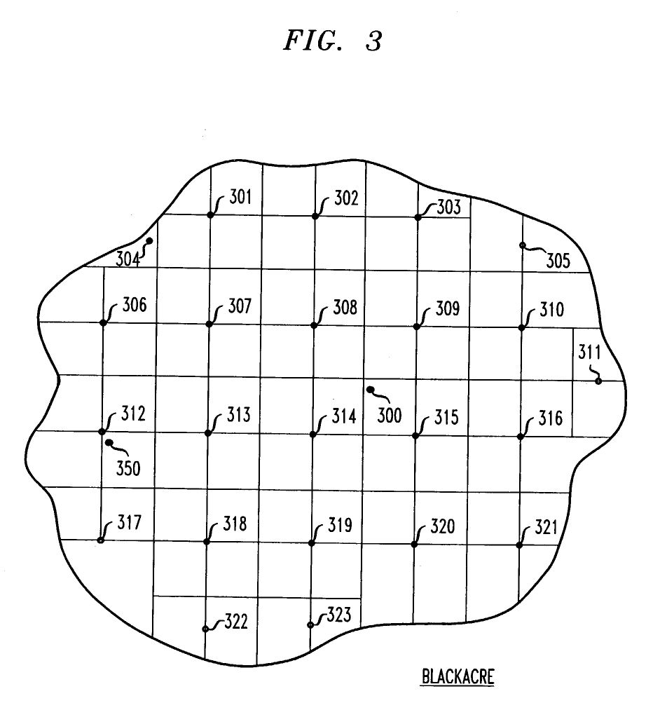

FIG. 4 depicts a functional block diagram of wireless switching center 300, which comprises: switch 401, broadcast server 402, and multiplexer 403. Switch 401 is responsible for providing telecommunications service to Blackacre. To this end, switch 401 interfaces with the local and long-distance networks, via lead 411, and base stations 301 through 323, via incoming leads 431-1 through 431-23 and outgoing leads 432-1 through 432-23. It will be clear to those skilled in the art how to make and use switch 401.

Broadcast server 402 is responsible for providing broadcast service to Blackacre, and to this end it is a general purpose computer that contains:

i. the messages to be broadcast into each geographic region, and

ii. an indication of which geographic regions should receive each message.

As stated above, each message can contain data, voice or video or any combination of these, and it will be clear to those skilled in the art how to chose a format (e.g., text, bitmap, html, gif, mpg, .wav, etc.) or combination of formats for each message. The source of the messages can be any entity (e.g., political authorities, school authorities, military authorities, advertisers, transportation authorities, etc.) that desires to broadcast a message and the possible subjects for a message include, school schedules, advertisements, political opinions, sports scores, special closings (for snow, etc.), zoning board announcements, stock reports, recycling schedules, rail & bus schedules, weather reports, movie and TV listings, emergency access numbers, etc.

Furthermore, because successive versions of a broadcast message can be transmitted (e.g., successive weather forcast messages, successive stock market reports, etc.), broadcast server 402 advantageously labels each broadcast message so that a receiver can identify each message and can discern when a received broadcast message should overwrite a previously received one.

It will be clear to those skilled in the art how to compose a message, enter it into broadcast server 402, and to indicate to broadcast server which geographic regions should receive each message.

For example, Table 1 presents six illustrative messages that are contained within broadcast server 402 and a list of the geographic regions that each is to be broadcast into. It will be clear to those skilled in the art that, in practice, broadcast server 402 is likely to contain substantially more than 6 messages.

TABLE 1
Messages in Broadcast Server 402

| Message | Message Description | Geographic Regions |
|---|---|---|
| 1 | River Flood Warning | 3-4, 10-11, 20, 29-31, 39-41, |
| | | 50-51, 60-61, 68-70 |
| 2 | Closing of School 223 | 1-36 |
| 3 | Congestion on | 15, 24-25, 33-34, 44-45, 54-55, |
| | Highway 211 | 63-64, 72, 79-80 |
| 4 | Sale at Mike's | 54-56, 64-66, 73-75 |
| | Flower Shop | |
| 5 | Cinema Movie | 17-21, 27-31, 38-42, 49-53, 59-63 |
| | Schedule | |
| 6 | Bridge Out | 16-17, 27-29, 39-41, 52-53, |
| | on Highway 212 | 63-65, 74-75 |

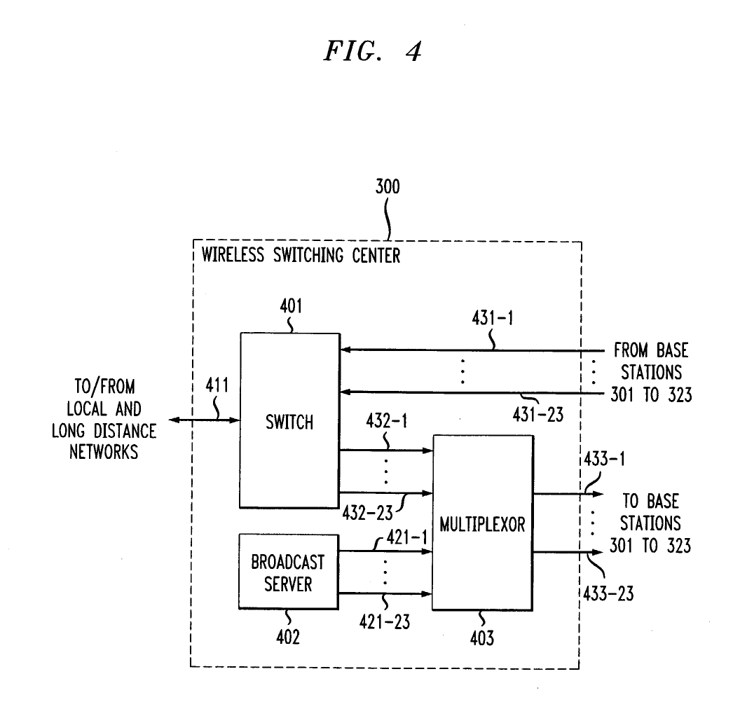

Message #1 is a river flood warning that might be published by political authorities for broadcast into those geographic regions adjacent to river 201. Therefore, broadcast server 402 transmits Message #1 through multiplexer 402 to base stations 302, 307, 308, 313, 314, 317 and 318 for broadcasting into geographic regions 3-4, 10-11, 20, 29-31, 39-41, 50-51, 60-61, and 68-70. FIG. 5 depicts a map of Blackacre where the geographic regions to receive Message #1 are hatched.

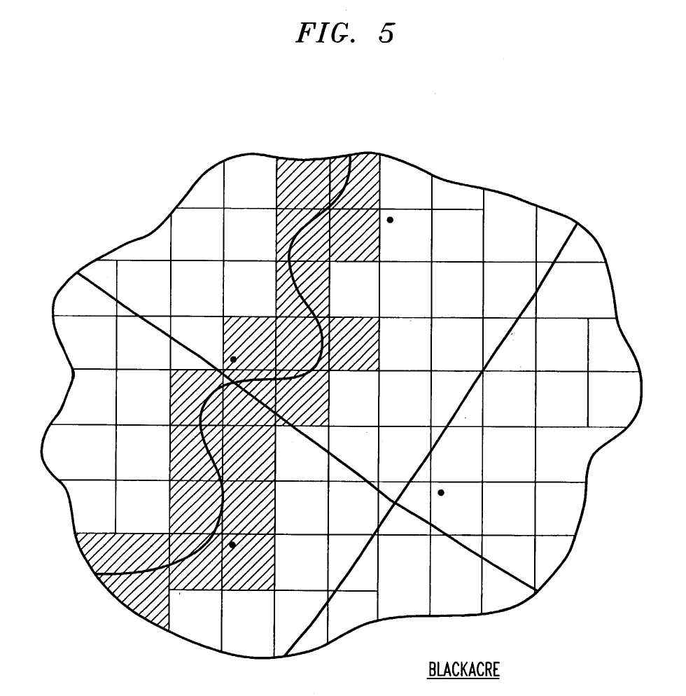

Message #2 is a school closing announcement that might be published by school authorities for broadcast into the geographic regions in the school district for school 223. Therefore, broadcast server 402 transmits Message #2 through multiplexer 402 to base stations 301 through 311 for broadcasting into geographic regions 1 through 36. FIG. 6 depicts a map of Blackacre where the geographic regions to receive Message #2 are hatched.

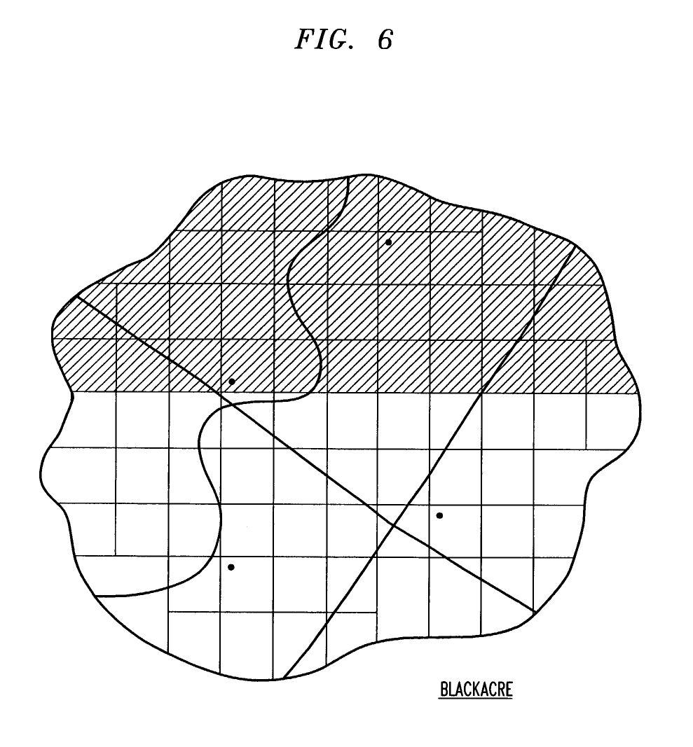

Message #3 is a traffic announcement that might be published by traffic authorities for broadcast into the geographic regions adjacent to highway 211. Therefore, broadcast server 402 transmits Message #3 through multiplexer 402 to base stations 305, 309, 310, 315, 316, 319, 320 and 323 for broadcasting into geographic regions 15, 24-25, 33-34, 44-45, 54-55, 63-64, 72, 79-80. FIG. 7 depicts a map of Blackacre where the geographic regions to receive Message #3 are hatched.

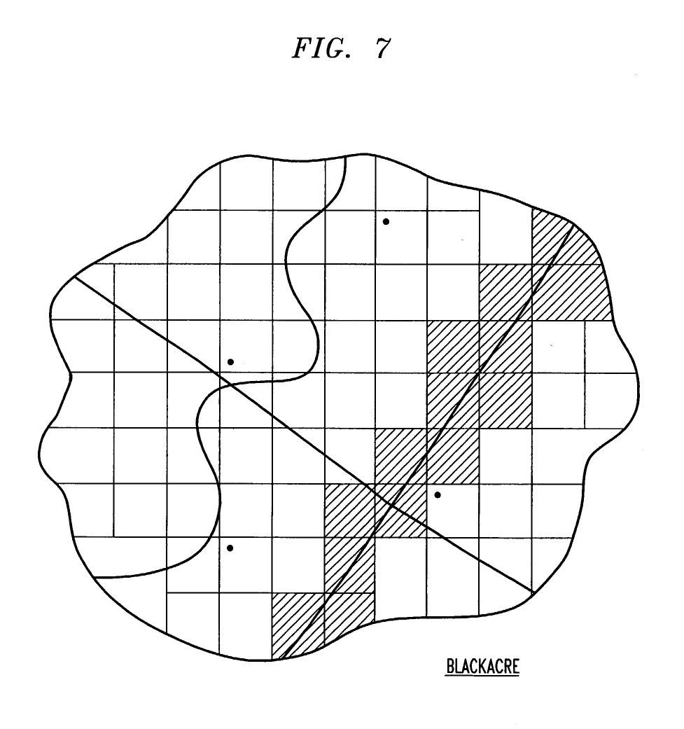

Message #4 is an advertisement for a sale at Mike's Flower Shop, which is located in business district 222 and geographic region #65. Although the advertisement might be equally relevant throughout Blackacre, and thus potentially broadcast into all 80 geographic regions, the cost of doing so might be prohibitive. In other words, the owner/operator of the illustrative embodiment might charge an advertiser an advertising fee that is based on the number of geographic regions that receive the advertisement. For example, it might cost Mike's Flower Shop too much money to broadcast Message #4 into all 80 geographic regions, and, therefore, Mike's Flower Shop might opt to broadcast into the 9 geographic regions closest to the shop. Therefore, broadcast server 402 transmits Message #4 through multiplexer 402 to base stations 315, 316, 320 and 321 for broadcasting into geographic regions 54-56, 64-66, 73-75. FIG. 8 depicts a map of Blackacre where the geographic regions to receive Message #4 are hatched.

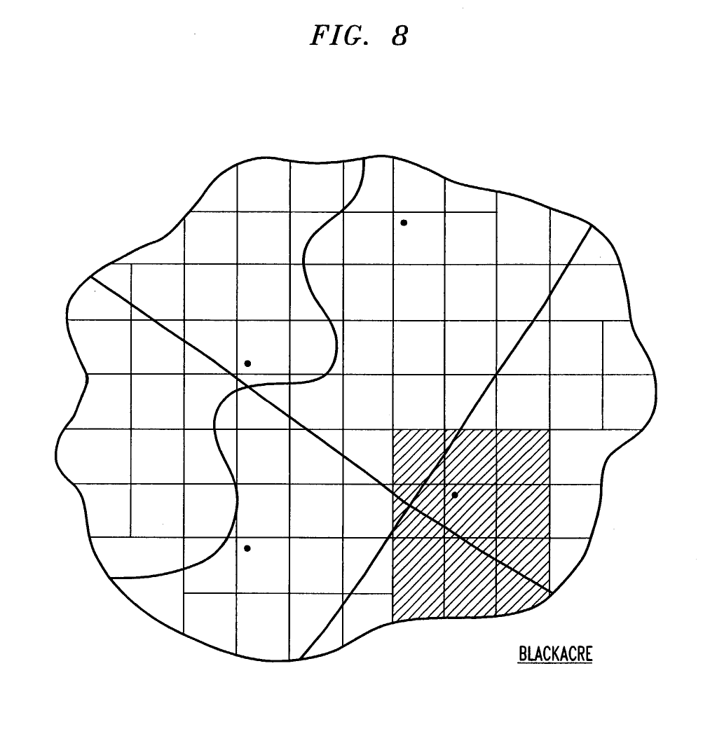

Message #5 is an advertisement for a Cinema's movie schedule, which is located in business district 221. Like Mike's Flower Shop, the Cinema has chosen to limit the number of geographic regions receiving its movie schedule, and, therefore, the movie schedule is to be broadcast into 25 geographic regions near it. Therefore, broadcast server 402 transmits Message #5 through multiplexer 402 to base stations 306, 307, 308, 312, 313, 314, 317, 318 and 319 for broadcasting into geographic regions 17-21, 27-31, 38-42, 49-53, 59-63. FIG. 9 depicts a map of Blackacre where the geographic regions to receive Message #5 are hatched.

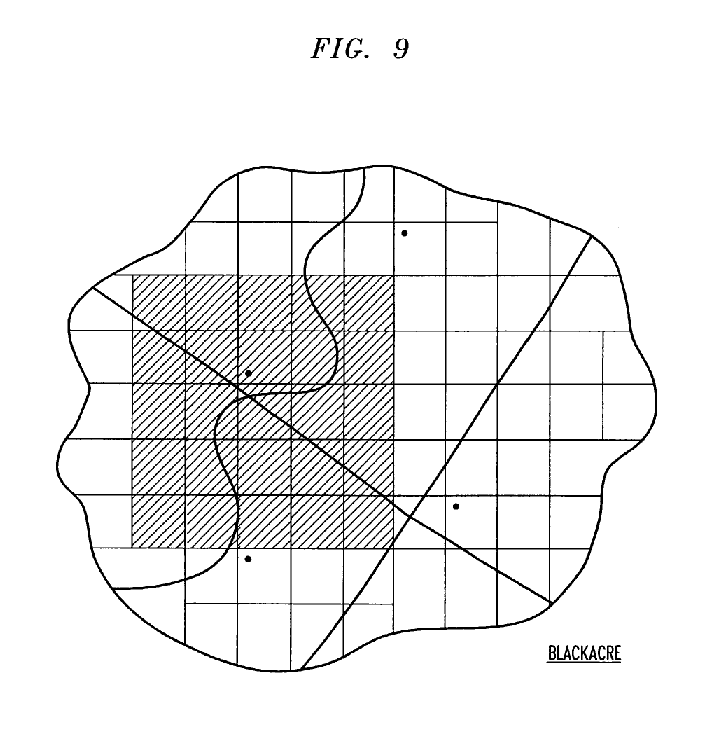

Message #6 is a traffic announcement regarding a washed-out bridge that might be published by traffic authorities for broadcast into the geographic regions adjacent to highway 212. Therefore, broadcast server 402 transmits Message #6 through multiplexer 402 to base stations 306, 307, 313, 314, 319, 320, and 321 for broadcasting into geographic regions 16-17, 27-29, 39-41, 52-53, 63-65, 74-75. FIG. 10 depicts a map of Blackacre where the geographic regions to receive Message #6 are hatched.

Therefore, it can be seen from Table 1 and FIGS. 5 through 10 that there are some geographic regions into which no messages are broadcast (e.g., geographic region 67, etc.) and there are some geographic regions into which one or more messages are broadcast (e.g., geographic region 29 receives Messages #1, 2, 5 and 6). In this way, the illustrative embodiment broadcasts messages to geographic areas where it is advantageous and yet conserves its available bandwidth.

A broadcast message can be broadcast once or more than once, periodically or sporadically, depending on the needs and desires of the owner/operator of the illustrative embodiment and the originator of the message. Furthermore, a message can be edited, in whole or in part, and the newly edited message broadcast in its place, which overwrites the previous version of the message stored in the receiver (as described below). It will be clear to those skilled in the art how to make and use broadcast server 402.

Multiplexer 403 is responsible for combining the downlink telecommunications traffic from switch 401 with the broadcast messages from broadcast server 402 for delivery to the base stations. It will be clear to those skilled in the art how to make and use multiplexer 403. Advantageously, only those broadcast messages to be broadcast by a base station are forwarded to the base station by multiplexer 403.

In an alternative embodiment of the present invention, broadcast server 402 can send all of the messages to be broadcast by any base station to all of the base stations with an indication of which geographic regions are to receive each message. In this case, each base station, rather than multiplexer 403, becomes responsible for ensuring that each message is broadcast into its appropriate geographic region. In either case, multiplexer 403 must multiplex the downlink telecommunications traffic from switch 401 to the base stations with the broadcast messages to the base stations from broadcast server 402.

Each base station can broadcast the broadcast messages with different radios and different communications channels than it uses for providing telecommunications service, but advantageously, each base station uses the same radios and communications channels for both. In fact, the broadcast messages are advantageously transmitted in an overhead channel that is received and decoded by all of the receivers in each geographic region. It will be clear to those skilled in the art how to multiplex the broadcast messages into one or more of the communications channels used to broadcast overhead information for the telecommunications service.

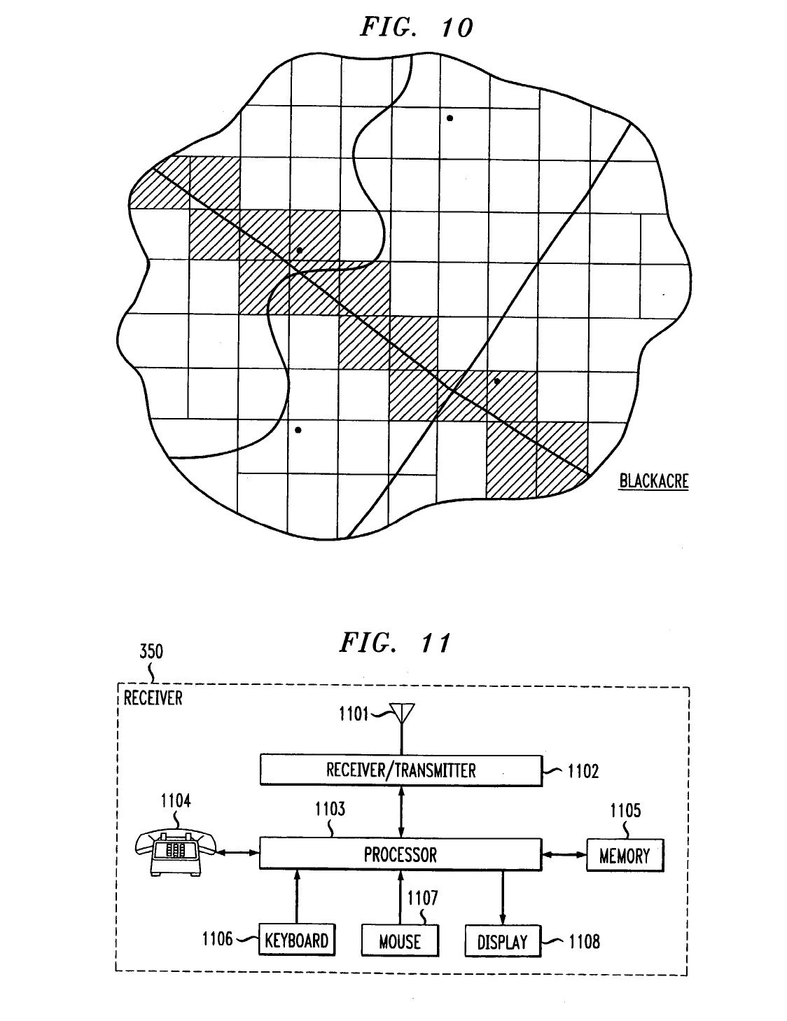

FIG. 11 depicts a functional block diagram of receiver 350, which is capable of providing telecommunications service and broadcast service to a user. Receiver 350 comprises: antenna 1101, transceiver 1102, processor 1103, telecommunications terminal 1104, memory 1105, keyboard 1106, mouse 1107, and display 1108.

Antenna 1101 and transceiver 1102 are used by receiver 350, in well-known fashion, for receiving telecommunications traffic and broadcast messages from a base station and for transmitting telecommunications traffic to a base station. Although telecommunications traffic is output from transceiver 1102 to processor 1103 only when it is intended for receiver 350, all broadcast messages that are received by transceiver 1102 are output to processor 1103. Telecommunications traffic intended for receiver 350 is forwarded by processor 1103 to telecommunications terminal 1104, which provides a human interface (e.g., speaker, microphone, keypad, etc.) for receiving the telecommunications traffic and for generating outgoing telecommunications traffic. Outgoing telecommunications traffic is generated by telecommunications terminal 1104, which forwards it to processor 1103, transceiver 1102 and antenna 1101 for transmission to a base station. A user can also use keyboard 1106 and mouse 1107 to generate outgoing telecommunications traffic, and display 1108 for receiving telecommunications traffic.

Processor 1103 is an appropriately-programmed general purpose computer that stores all of the received broadcast messages in memory 1105, rather than immediately outputting them to the user. In other words, although a typical receiver of broadcasting (e.g., a television set, an AM radio, etc.) outputs all received messages immediately, the illustrative embodiment stores them for later examination at the user's convenience. Furthermore, processor 1103 advantageously stores only one version of a broadcast message, the most recently received version, when multiple versions of a broadcast message are received. Therefore, processor 1103 tags each received message with the date and time is was received and automatically overwrites an older version of a broadcast message when an updated version of the broadcast message is received. Important broadcast messages (e.g., those pertaining to civil defense emergencies, a special promotion at a fast-food restaurant, etc.) can be tagged by broadcast receiver 402 so that their arrival at receiver 350 causes receiver 350 to alert the user (e.g., by ringing a special ring, by lighting a lamp, by vibrating, etc.) that an important broadcast message has arrived that warrants the immediate attention of the user.

At any time, the user of receiver 350 can use keyboard 1106, mouse 1107 and display 1108 to review any or all of the broadcast messages stored in memory 1105. Furthermore, if a broadcast message contains a telephone number, processor 1103 can, at the user's request, automatically initiate a telecommunications call to that number so that the user can communicate with the owner of that number. For example, a broadcast message that is an advertisement for a special at a restaurant might contain the telephone number of the restaurant to facilitate the making of reservations at the restaurant. Therefore, upon the request of the user, processor 1103 can initiate call between telecommunications terminal 1104 and the restaurant.

One advantage of storing the broadcast messages locally for later examination is that this enables the user to examine many hour's or day's worth of messages in a short amount of time, rather than having to be constantly examining each message as it is received. Another advantage of storing the broadcast messages locally for later examination is that it affords the user some privacy in that it allows the user to browse through the broadcast messages without revealing to the outside world which particular messages he or she is interested in. This is in stark contrast to the World Wide Web, which requires that a user “telegraph” over the Web to the entire world what content he or she is interested in.

It is to be understood that the above-described embodiments are merely illustrative of the invention and that many variations might be devised by those skilled in the art without departing from the scope of the invention. It is therefore intended that such variations be included within the scope of the following claims and their equivalents.

What is claimed is:

1. A system comprising:
a first transmitter for broadcasting into a first geographic region;
a second transmitter for broadcasting into a second geographic region; and
a broadcast server for providing a first message to said first transmitter for broadcasting into said first geographic region, a second message to said second transmitter for broadcasting into said second geographic region, and a third message to said first transmitter for broadcasting into said first geographic region and to said second transmitter for broadcasting into said second geographic region;
wherein said broadcast server labels said first message so that a receiver of said first message can discern whether said first message should overwrite a previously received message.

2. The system of claim 1 wherein said first geographic region and said second geographic region are contiguous.

3. The system of claim 1 wherein said first transmitter and said second transmitter are each wireless transmitters.

4. The system of claim 1 wherein said first transmitter and said second transmitter are each wireline transmitters.

5. The system of claim 1 wherein said first transmitter provides telecommunications service to said first geographic region and said second transmitter provides telecommunications service to said second geographic region.

6. The system of claim 1 wherein said first transmitter broadcasts said first message in an overhead channel.

7. A method comprising:
providing from a broadcast server a first message for broadcasting into a first geographic region, a second message for broadcasting into a second geographic region, and a third message for broadcasting into a third geographic region, wherein said first message is labeled so that a receiver of said first message can discern whether said first message should overwrite a previously received message;
broadcasting from a first transmitter said first message into said first geographic region;
broadcasting from a second transmitter said second message into a second geographic region; and
broadcasting said third message into said first geographic region from said first transmitter and said second geographic region from said second transmitter.

8. The method of claim 7 wherein said first geographic region and said second geographic region are contiguous.

9. The method of claim 7 wherein said first transmitter and said second transmitter are each wireless transmitters.

10. The method of claim 7 wherein said first transmitter and said second transmitter are each wireless transmitters.

11. The method of claim 7 wherein said first transmitter provides telecommunications service to said first geographic region and said second transmitter provides telecommunications service to said second geographic region.

12. The method of claim 7 wherein said first message is broadcasted in an overhead channel.

13. A wireless telecommunications system comprising:
a first base station for providing telecommunications service to a first geographic region and for periodically broadcasting into said first geographic region;
a second base station for providing telecommunications service to a second geographic region and for broadcasting into said second geographic region;
a switch connected to said first base station and to said second base station for providing telecommunications service to said first geographic region and said second geographic region; and
a broadcast server for providing a first message to said first base station for broadcasting in an overhead channel into said first geographic region, a second message to said second base station for broadcasting into said second geographic region, and a third message to said first base station for broadcasting into said first region and to said second base station for broadcasting into said second geographic region.

14. The wireless telecommunications system of claim 13 wherein said first message, said second message and said third message are advertising.

15. A method of operating a wireless telecommunications system comprising:
providing telecommunications service to a first geographic region with a first transmitter;
periodically broadcasting a first message into said first geographic region with said first transmitter;
providing telecommunications service to a second geographic region with a second transmitter;
broadcasting a second message into said second geographic region with said second transmitter; and
broadcasting a third message into said first geographic region with said first transmitter and said second geographic region with said second transmitter.

16. The method of claim 15 wherein said first geographic region and said second geographic region are contiguous.

17. A system comprising:
a first transmitter for broadcasting into a first geographic region;
a second transmitter for broadcasting into a second geographic region; and
a broadcast server for providing a first message to said first transmitter for broadcasting into said first geographic region, a second message to said second transmitter for broadcasting into said second geographic region, and a third message to said first transmitter for broadcasting into said first geographic region and to said second transmitter for broadcasting into said second geographic region.
wherein said first transmitter broadcasts said first message to a receiver without a request from said receiver for said first message.

18. The system of claim 17 wherein said first transmitter and said second transmitter are each wireline transmitters.

19. The system of claim 17 wherein said first transmitter provides telecommunications service to said first geographic region and said second transmitter provides telecommunications service to said second geographic region.

20. A method comprising:
providing from a broadcast server a first message for broadcasting into a first geographic region, a second message for broadcasting into a second geographic region, and a third message for broadcasting into a third geographic region;
broadcasting from a first transmitter to a receiver in said first geographic region said first message, wherein said first transmitter broadcasts said first message to said receiver without a request from said receiver for said first message;
broadcasting from a second transmitter said second message into a second geographic region; and
broadcasting said third message into said first geographic region from said first transmitter and said second geographic region from said second transmitter.

21. The method of claim 20 wherein said first transmitter and said second transmitter are each wireless transmitters.

22. The method of claim 20 wherein said first transmitter provides telecommunications service to said first geographic region and said second transmitter provides telecommunications service to said second geographic region.

23. A system comprising:
a first transmitter for broadcasting into a first geographic region;
a second transmitter for broadcasting into a second geographic region; and
a broadcast server for providing a first message to said first transmitter for broadcasting into said first geographic region, a second message to said second transmitter for broadcasting into said second geographic region, and a third message to said first transmitter for broadcasting into said first geographic region and to said second transmitter for broadcasting into said second geographic region.

24. The system of claim 23 wherein said first transmitter and said second transmitter are each wireline transmitters.

25. The system of claim 23 wherein said first transmitter provides telecommunications service to said first geographic region and said second transmitter provides telecommunications service to said second geographic region.

26. A method comprising:
providing from a broadcast server a first message for broadcasting into a first geographic region, a second message for broadcasting into a second geographic region, and a third message for broadcasting into a third geographic region;
periodically broadcasting from a first transmitter to a receiver in said first geographic region said first message, wherein said first transmitter broadcasts said first message to said receiver without a request from said receiver for said first message;
broadcasting from a second transmitter said second message into a second geographic region; and
broadcasting said third message into said first geographic region from said first transmitter and said second geographic region from said second transmitter.

27. The method of claim 26 wherein said first transmitter and said second transmitter are each wireless transmitters.

28. The method of claim 26 wherein said first transmitter provides telecommunications service to said first geographic region and said second transmitter provides telecommunications service to said second geographic region.
